(19) United States
(12) Patent Application Publication
(10) Pub. No.: US 2005/0052132 A1
(43) Pub. Date: Mar. 10, 2005

(54) Plasma display panel

(76) Inventor: Oe Dong Kim, Seongnam-si (KR)

Correspondence Address: FLESHNER & KIM, LLP, P.O. BOX 221200, CHANTILLY, VA, 20153, US

(21) Appl. No.: 10/912,558

(22) Filed: Aug. 6, 2004

(30) Foreign Application Priority Data
Aug. 9, 2003 (KR) 10-2003-0055204

(51) Int. Cl. H01J 1/62; H01J 63/04

(52) U.S. Cl. 313/510; 313/504

(57) ABSTRACT

The present invention relates to a plasma display panel capable of increasing emission efficiency and color temperature. The plasma display panel according to an embodiment of the present invention having diaphragms for separating display cells that are adjacent between an upper substrate and a lower substrate and R, G and B phosphors formed between the diaphragms, wherein the shape of the diaphragms that surround rsepective display cells of the R, G and B phosphors and the shape of the diaphragms that surround the entire R, G and B phosphors are square, two display cells among the display cells of the R, G and B phosphors are juxtaposed vertically at the top, and the remaining one display cell is formed at the bottom horizontally. Therefore, the present invention has an effect that it can increase emission efficiency and color temperature.

This Nonprovisional application claims priority under 35 U.S.C. § 119(a) on Patent Application No. 10-2003-0055204 filed in Korea on Aug. 9, 2003, the entire contents of which are hereby incorporated by reference.

### BACKGROUND OF THE INVENTION

1. Field of the Invention

The present invention relates to a plasma display panel and more particularly, to a plasma display panel capable of increasing emission efficiency and color temperature.

2. Description of the Background Art

In a plasma display panel (hereinafter, referred to as “PDP”), fluorescent materials are emitted by ultraviolet rays of 147 nm that are generated upon discharge of He+Xe or Ne+Xe gas, thus displaying an image including characters or graphics. Such a PDP has characteristics that it can be easily made large, and has a good image quality and a rapid response speed. Furthermore, as such a PDP can be easily made thin, attention to this PDP has been paid as a display for a wall mount along with a liquid display panel (LCD), etc.

A PDP can be largely classified into a surface discharge type and an opposite type depending on the structure that electrodes are arranged, and can be classified into an AC type, a DC type or a hybrid type depending on whether electrodes are exposed or not. More particularly, a 3-electrode AC surface discharge type PDP has advantages of low-voltage driving and long life shape since wall charges are accumulated on its surface upon discharge and electrodes are protected from sputtering generated by the discharge.

FIG. 1 is a cross-sectional view illustrating the structure of a typical AC surface discharge type plasma panel. Referring to FIG. 1, the common AC surface discharge type PDP includes a lower substrate 1, an address electrode X formed on the lower substrate 1, a lower dielectric layer 2 formed on the address electrode X, and a diaphragm 3 formed on the lower dielectric layer 2 for maintaining a discharge distance and preventing electrical and optical crosstalk among cells, wherein the diaphragm 3 accommodates phosphors 4.

Furthermore, a protect film 5 is formed on an upper dielectric layer 6. The protect film 5 serves to increase the life span by preventing sputtering of the upper dielectric layer 6 due to a gas ion during a discharge and to decrease a discharge start voltage through secondary electron emission. If the discharge start voltage decreases, not only a stabilized discharge can be obtained but also the life span of the electrodes is extended. A space between the protect film 5 and the phosphors 4 is filled with an insert gas such as Ne+Xe or He+Xe.

Moreover, a scan electrode Y and a sustain electrode Z are formed on an upper substrate 7 of the PDP. The two electrodes Y and Z include ITO (Indium-Tin-Oxide) electrodes that are transparent electrodes so that they do not hinder light transmission of the upper substrate 7. Also, in order to prevent a voltage drop of the two electrodes Y and Z, a bus electrode B being a metal electrode that has a smaller area than the two electrodes are provided.

The upper dielectric layer 6 are formed on the scan electrode Y and the sustain electrode Z. The upper dielectric layer 6 serves to limit the plasma discharge current and to accumulate wall charges thereon at the time of a discharge.

The operating principle of the PDP will now be described with reference to FIG. 1. A voltage corresponding to a discharge sustain voltage is applied between the scan electrode Y and the sustain electrode Z so that charges are accumulated on the upper dielectric layer 6.

If a voltage corresponding to a discharge start voltage is applied to the address electrode X, the insert gas is divided into electrons and ions by means of a glow discharge and is then plasmized. The phosphors 4 emit colors by means of ultraviolet rays that are generated when the electrons and ions are combined.

A diaphragm structure and an electrode structure of the upper substrate and the lower substrate of the conventional PDP constructed above will be described with reference to the accompanying FIGS. 2, 3 and 4.

FIGS. 2 and 3 illustrate a conventional stripe type diaphragm structure and a well type diaphragm structure, and electrode structure therefor. Referring to FIGS. 2 and 3, a plurality of stripe type diaphragms (3 in FIG. 2(b)) and well type diaphragms (3 in FIG. 3(b)) are arranged in the lower substrate in parallel at a give width. Address electrodes X are formed between the diaphragms 3.

Pairs of scan electrodes Y and sustain electrodes Z are formed on the upper substrate 7 in the direction that they intersect the address electrodes X formed in the lower substrate 1.

However, the stripe type diaphragm structure and the well type diaphragm structure have a problem that emission efficiency is low because a covering area of phosphors is small.

A diaphragm structure for solving this problem is shown in FIG. 4.

FIG. 4 illustrates a square delta diaphragm structure and an electrode structure therefor. Referring to FIG. 4, scan electrodes Y and sustain electrodes Z that are formed in the similar manner as the stripe type diaphragm structure and the well type diaphragm structure are formed on the upper substrate 7 to have a Y-Z-Y-Z structure. Address electrodes X that intersect the scan electrodes Y and the sustain electrodes Z are formed on the lower substrate 1. Display (discharge) cells of R, G and B phosphors are formed at their intersections.

In addition, display cells of the R, G and B phosphors have a triangular structure. Each of the display cells of the R, G and B phosphors having the triangular structure is completely surrounded by the diaphragm 3, so that the diaphragm 3 forms a matrix structure.

However, plasma display panels having the conventional stripe type diaphragm structure and the well type diaphragm structure have a problem that efficiency is low because a covering area of phosphors is small.

Moreover, the conventional square delta diaphragm structure has a structure that phosphors are formed in a zigzag shape because the display cells of the R, G and B phosphors have the triangular shape. Accordingly, there is a problem in that image quality is degraded.

### SUMMARY OF THE INVENTION

Accordingly, an object of the present invention is to solve at least the problems and disadvantages of the background art.

An object of the present invention is to provide a plasma display panel that is capable of increasing emission efficiency and color temperature.

According to an embodiment of the present invention, there is provided, including a plasma display panel having diaphragms for separating display cells that are adjacent between an upper substrate and a lower substrate and R, G and B phosphors formed between the diaphragms, wherein the shape of the diaphragms that surround respective display cells of the R, G and B phosphors and the shape of the diaphragms that surround the entire R, G and B phosphors are square, two display cells among the display cells of the R, G and B phosphors are juxtaposed vertically at the top, and the remaining one display cell is formed at the bottom horizontally.

The present invention has effects that the aperture ratio increased since a diaphragm structure and an electrode arrangement of an upper substrate and a lower substrate are varied, and emission efficiency and color temperature are thus increased.

### BRIEF DESCRIPTION OF THE DRAWINGS

The invention will be described in detail with references to the following drawings in which like numerals refer to like elements.

FIG. 1 is a cross-sectional view illustrating the structure of a common AC surface discharge type plasma display panel.

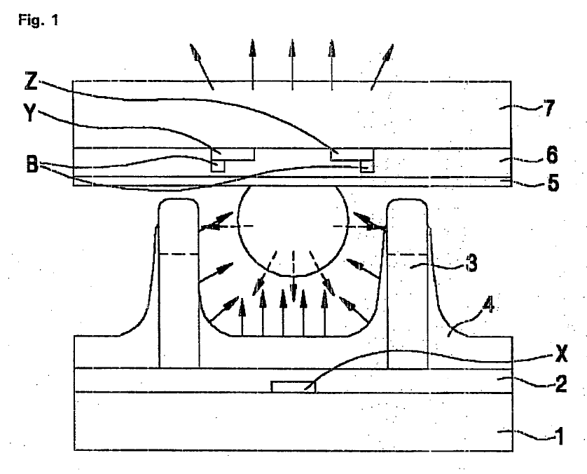

FIG. 2 illustrates a conventional stripe diaphragm structure and an electrode structure of an upper substrate and a lower substrate b therefor.

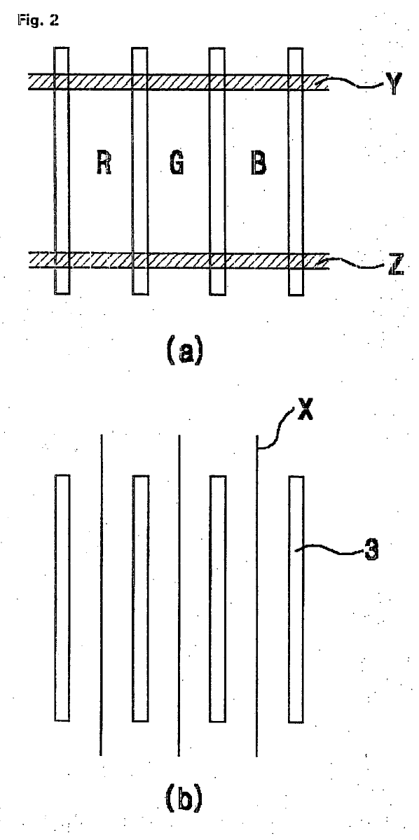

FIG. 3 illustrates a conventional well diaphragm structure and an electrode structure of an upper substrate and a lower substrate b therefor.

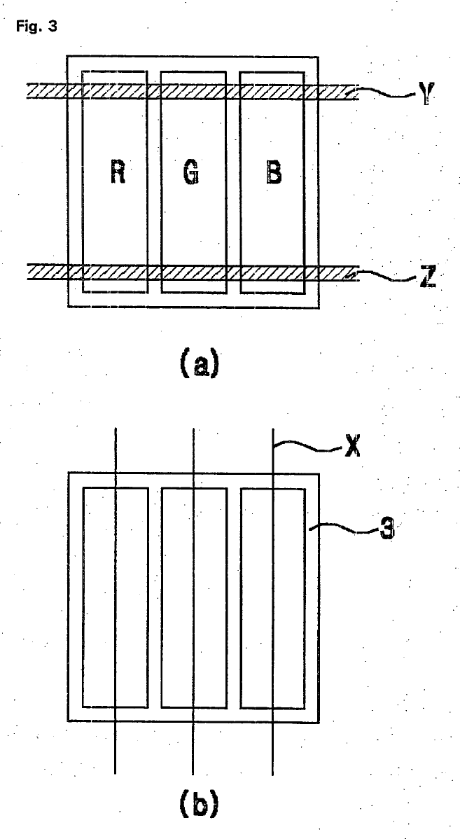

FIG. 4 illustrates a conventional square delta diaphragm structure and an electrode structure of an upper substrate and a lower substrate b therefor.

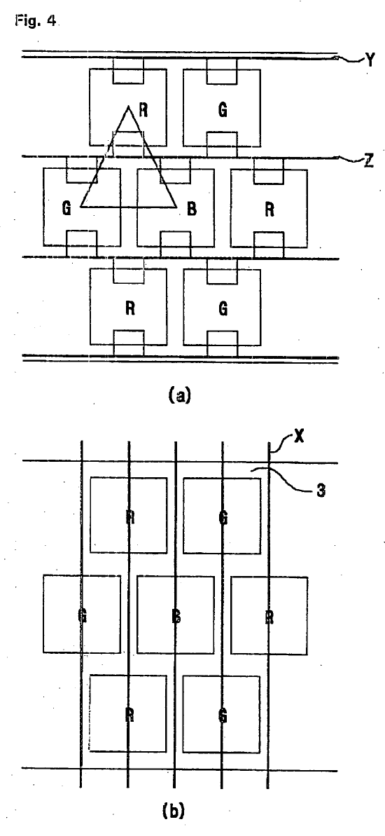

FIG. 5 illustrates a diaphragm structure and an electrode structure of an upper substrate and a lower substrate therefore, of a plasma display panel according to the present invention.

### DETAILED DESCRIPTION OF PREFERRED EMBODIMENTS

Preferred embodiments of the present invention will be described in a more detailed manner with reference to the drawings.

According to an embodiment of the present invention, there is provided including a plasma display panel having diaphragms for separating display cells that are adjacent between an upper substrate and a lower substrate and R, G and B phosphors formed between the diaphragms, wherein the shape of the diaphragms that surround respective display cells of the R, G and B phosphors and the shape of the diaphragms that surround the entire R, G and B phosphors are square, two display cells among the display cells of the R, G and B phosphors are juxtaposed vertically at the top, and the remaining one display cell is formed at the bottom horizontally.

Furthermore, the width of vertical diaphragms of the display cells formed at the top is narrower than the width of vertical diaphragms of the display cell formed at the bottom.

Moreover, the ratio of the length of the vertical diaphragm of the upper display cells and the length of the vertical diaphragm of the lower display cell is 3:2.

In addition, the width of the vertical diaphragm of the lower display cell is 360 to 400 um.

Also, in an address electrode of the display cell, a bus bar has a straight shape but has a wide electrode structure within the display cell.

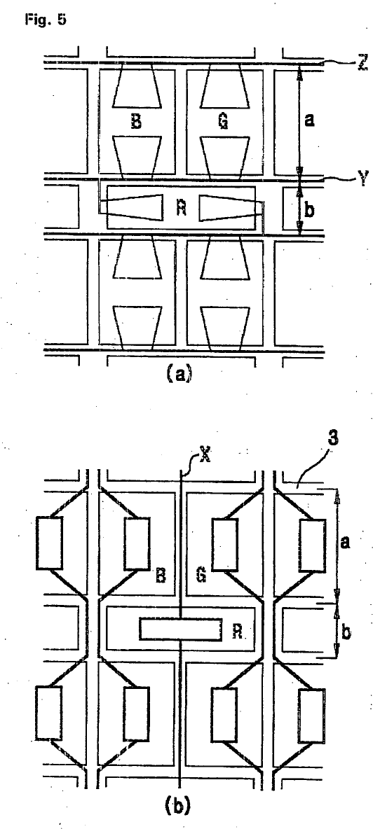

FIG. 5 illustrates a diaphragm structure and an electrode structure of an upper substrate and a lower substrate therefore, of a plasma display panel according to the present invention. As shown in FIG. 5, the shape of each of diaphragms 3 that accommodate R, G and B phosphors is square.

Furthermore, two display cells among display cells of the R, G and B phosphors are juxtaposed vertically and the remaining one display cell is formed at the bottom horizontally. Through this structure, the display cell formed at the bottom has a cell size corresponding to that of a conventional stripe structure. The two display cells formed at the top have a diaphragm structure of an almost square shape. Thus, the aperture ratio of the cell increases.

At this time, if a width of the horizontal diaphragm 3 is wide enough to prevent an erroneous discharge due to the bus electrodes Y and Z and a width of the bus electrode is about 65 um, a width of the horizontal diaphragm is made 200 um that is three times as wide as the width of the bus electrode. Also, if the ratio of (a) and (b) that are the lengths of the vertical diaphragms of the display cells each formed at the top and bottom of FIG. 5a and FIG. 5b is about 3:2, the two display cells formed at the top of the diaphragm becomes square.

The width of the vertical diaphragm 3 is different in the display cells formed at the top of the diaphragms and the display cells formed at the bottom of the diaphragms. In the address electrode X of the lower substrate shown in FIG. 5(b), a width of the vertical diaphragm 3 between the two display cells at the top of the diaphragm is determined not to be affected by the address electrode X that passes through the display cell formed at the bottom of the diaphragm. In other words, the width of the vertical diaphragm 3 between the upper two display cells can be twice as wide as the width of the address electrode X.

Meanwhile, if the diaphragm 3 is fabricated, a width of the bottom of the diaphragm 3 becomes further wide. Thus, an actual width of the top of the diaphragm has the size of the same as a width of the address electrode X. On the contrary, since a width of the vertical diaphragm 3 of the lower display cell has to be determined so that the address electrodes X of the two display cells formed at the top of the diaphragm must pass while keeping a constant distance and must be projected into the inner space of the lower display cell, a width of the vertical diaphragm 3 must be further wider than a width of the vertical discharge 3 of the upper display cell.

If it is assumed that the width of the address electrode X is about 90 um and a distance between the electrodes is about 120 um, a width of the vertical diaphragm of the lower display cell becomes about 360 to 400 um. Emission efficiency is increased by this diaphragm structure and electrode arrangement.

Furthermore, as shown in FIG. 5, according to the present invention, G display cells are placed in one of the two display cells formed at the top of the diaphragm and one of the R and B display cells is disposed in the remaining display cell formed at the top of the diaphragm. Generally, as brightness of B is low, color temperature can be increased by forming the B display cell in the upper display cell.

Moreover, as shown in FIG. 5(b), a bus bar in the address electrode structure has a straight shape. Thus, by making the bur bas have a wide electrode structure, it is possible to improve address characteristics.

According to the present invention as described above, the entire diaphragms that surround display cells of R, G and B phoshors are formed square. Also, two display cells are formed at the top of the entire diaphragms vertically and one display cell is formed at the bottom of the entire diaphragms horizontally. Therefore, the present invention has effects that the aperture ratio increased since a diaphragm structure and an electrode arrangement of an upper substrate and a lower substrate are varied, and emission efficiency and color temperature are thus increased.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display panel having diaphragms for separating display cells that are adjacent between an upper substrate and a lower substrate, and R, G and B phosphors formed between the diaphragms,
wherein the shape of the diaphragms that surround the respective display cells of the R, G and B phosphors and the shape of the diaphragms that surround the entire R, G and B phosphors are square, two display cells among the display cells of the R, G and B phosphors are juxtaposed vertically at the top, and the remaining one display cell is formed at the bottom horizontally.

2. The plasma display panel as claimed in claim 1, wherein a width of the vertical diaphragms of the display cells formed at the top is narrower than a width of the vertical diaphragms of the display cell formed at the bottom.

3. The plasma display panel as claimed in claim 2, wherein the ratio of the length of the vertical diaphragm of the upper display cells and the length of the vertical diaphragm of the lower display cell is 3:2.

4. The plasma display panel as claimed in claim 2, wherein the width of the vertical diaphragm of the lower display cell is 360 to 400 um.

5. The plasma display panel as claimed in claim 1, wherein in an address electrode of the display cell, a bus bar has a straight shape, but has a wide electrode structure within the display cell.
